(19) United States
(12) Patent Application Publication
(10) Pub. No.: US 2008/0186177 A1
(43) Pub. Date: Aug. 7, 2008

(54) Encoding apparatus and method of using the same

(75) Inventors: Pavel Nikitin, Seattle, WA (US); Venkata Kodukula, Bothell, WA (US); Markus Frank, Torslanda (SE); Rene Martinez, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Intermec IP Corp., Everett, WA (US)

(21) Appl. No.: 11/702,941

(22) Filed: Feb. 5, 2007

(51) Int. Cl. G08B 13/14

(52) U.S. Cl. 340/572.1

(57) ABSTRACT

A media processing apparatus includes a self-calibrating encoding assembly that send read/write inquires to determine appropriate power levels for encoding encodable objects. The apparatus includes a control subsystem that tracks the power levels of the encoding assembly and the corresponding positions of media carrying the encodable objects. The controller then determines an encoding window and an encoding power level at which the encoding assembly encodes an encodable object in the encoding power window without unwanted communication to encodable objects outside of the window.

### TECHNICAL FIELD

The present disclosure generally relates to encodable object preparation apparatuses, devices, and methods and, more particularly, to a media processing apparatus that wirelessly encodes information in encodable objects, for example, RFID devices.

### BACKGROUND INFORMATION

The automatic data collection (ADC) field includes a variety of different types of encodable objects (e.g., encodable objects used in RFID devices) and readers operable to read the data encoded in those encodable objects. A media or substrate often carries an array of encodable objects linearly spaced at predetermined increments through an encoding system. The encoding system can send a power signal conveying information to the encodable object such that the power signal energizes the encodable object's circuitry, thereby encoding information in the encodable object. The system encodes one encodable object at a time based on user inputted encoding parameters such as the spacing of the encodable objects. Manufacturers of encodable objects may provide information so that the user can manually program the encoding system. If proper encoding parameters are not inputted, the system sends unwanted signals to non-targeted encodable objects resulting in programming errors.

To prepare sets of encodable objects spaced at different increments, the user has to separately input the encoding parameters for each set of encodable objects. To ensure proper and consistent encoding, the system is inputted with numerous encoding parameters, including encodable object size, required encoding power, pitch of the encodable objects, power of interrogation signal, and other parameters based on the design of the encodable object and desired feed rates.

If a single system is used to encode data to various types of encodable objects, the settings of the system are manually adjusted to prevent unwanted communication to non-targeted encodable objects. The power level of the system may have to be precisely set using the manufacturer's product specifications to ensure that targeted encodable objects are encoded without encoding or communicating with non-targeted encodable objects.

The present disclosure is directed to overcome one or more of the problems noted above and provide further related advantages.

### BRIEF SUMMARY

In some embodiments, an apparatus for preparing media is provided. The media can include a plurality of encodable objects spaced from one another along a length of the media. The apparatus comprises a media path along which the media travels, a write subsystem, a read subsystem, and a control subsystem. The write subsystem is configured to wirelessly transmit information for successively encoding the encodable objects as each of the encodable objects is proximate a first position along the media path. The read subsystem is configured to read information encoded in at least one of the encodable objects, if any, and to provide a signal indicative of whether the write subsystem has encoded the information in at least one of the encodable objects. The control subsystem is communicatively coupled to the write subsystem and the read subsystem and configured to advance the media along the media path in response to the signal from the read subsystem indicating that the write subsystem has encoded the information on a respective one of the encodable objects and to wirelessly retransmit the information at a higher power level in response to the signal from the read subsystem indicating that information previously transmitted by the write subsystem was not encoded on the respective one of the encodable objects.

In some other embodiments, an apparatus for preparing a plurality of encodable objects comprises a control subsystem and a write subsystem communicatively coupled to the control subsystem. The write subsystem is configured to wirelessly transmit information for encoding at least one of the encodable objects. A read subsystem is communicatively coupled to the control subsystem. The read subsystem is configured to wirelessly read information encoded in one of the encodable objects, if any. The apparatus can further comprise a position detector configured to detect a position of the plurality of the encodable objects and to send a signal indicative of the position of the plurality of encodable objects. The control subsystem is configured to determine an encoding window based, in part, on a plurality of position signals from the position detector and a plurality of transmission power levels of the write subsystem at which the write subsystem transmitted information and to determine an operational transmission power level for the write subsystem such that the write subsystem at the operational signal indicative power level encodes information in one of the encodable objects in the encoding window without encoding that information in any of the encodable objects outside of the encoding window.

In some embodiments, a method of preparing a plurality of encodable objects is provided. The method comprises wirelessly transmitting information from a write subsystem at a first power level. A read subsystem determines whether the information wirelessly transmitted from the write subsystem is encoded in at least one of the encodable objects. A response is generated based, at least in part, on the determining of whether the write information from the write subsystem is encoded in at least one of the encodable objects, if any. In response to determining that the information wirelessly transmitted by the write subsystem at the first power level is encoded in one of the encodable objects, the response comprises moving the plurality of encodable objects relative to at least a portion of the write subsystem. Alternatively, in response to determining that the information wirelessly transmitted by the write subsystem at the first power level is not encoded in at least one of the encodable objects, the response comprises wirelessly transmitting the information from the write subsystem at a second power level, and determining whether the information wireless transmitted from the write subsystem at the second power level is encoded in at least one of the encodable objects.

In other embodiments, a method of preparing a plurality of encodable objects is provided. The method comprises alternatingly wirelessly transmitting information from a write subsystem at a first plurality of power levels and determining with a read subsystem whether the information wirelessly transmitted from the write subsystem is encoded in a respective encodable object, if any. After determining that information from the write subsystem is encoded in the respective encodable object, moving the plurality of encodable objects relative to at least a portion of the write subsystem. After moving the plurality of encodable objects, information is wirelessly transmitted from the write subsystem at a second plurality of power levels. The read subsystem determines whether the information wirelessly transmitted from the write subsystem at the second plurality of power levels is encoded on the previously encoded encodable object or another encodable object.

In yet other embodiments, a method for preparing a plurality of spaced apart encodable objects movable along a processing path with an encoding apparatus is provided. The encoding apparatus comprises a write subsystem and a read subsystem. The method comprises determining an operational wireless transmission power level for the write subsystem to wirelessly transmit information and determining an encoding window such that, when the write subsystem is at the operational wireless transmission power level, the write subsystem encodes information in any of the encodable objects in the encoding window without encoding that information in any of the encodable objects outside of the encoding window.

In some embodiments, an apparatus is provided for preparing a plurality of encodable objects movable along a processing path, wherein the plurality of encodable objects are capable of storing and transmitting information. The apparatus comprises a write subsystem configured to wirelessly transmit information, a read subsystem configured to receive information transmitted from at least one of the encodable objects, a position detector for determining positions of the encodable objects relative to at least a portion of the apparatus, and a control subsystem. The control subsystem is communicatively coupled to the write subsystem, the read subsystem, and the position detector. The control subsystem is configured to wirelessly transmit information from the write subsystem at a plurality of power levels and to attempt to read information with the read subsystem to determine whether the information wirelessly transmitted from the write subsystem was stored in one of the encodable objects when the encodable objects are at different positions along the processing path and to track at least some of the plurality of power levels of the write system and corresponding positions of the plurality of encodable objects.

### BRIEF DESCRIPTION OF THE SEVERAL VIEWS OF THE DRAWINGS

Non-limiting and non-exhaustive embodiments are described with reference to the following drawings, wherein like reference numerals refer to like parts or acts throughout the various views unless otherwise specified. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an apparatus that encodes information in encodable objects carried by a media, in accordance with one illustrated embodiment.

FIG. 2 is a pictorial view of an encoding apparatus encoding encodable objects carried by a continuous sheet of media.

FIG. 3 is a pictorial view of the encoding apparatus of FIG. 2 encoding another sheet of media having encodable objects different than the encodable objects of FIG. 2.

FIG. 4 is a schematic diagram of an encoding assembly, in accordance with one illustrated embodiment.

FIG. 5 is a flow diagram of an exemplary method of calibrating an encoding apparatus.

FIG. 6 is a graph of power levels of a write subsystem of an encoding apparatus versus the position of the media.

FIG. 7 is a graph of power level curves of a write subsystem of an encoding apparatus versus the position of the media.

FIG. 8 is an isometric view of a write subsystem encoding a single encodable object in an encoding window.

FIG. 9 is a side elevational view of the write subsystem of FIG. 8 encoding the encodable object of FIG. 8.

FIG. 10 is a flow diagram of another exemplary method of calibrating an encoding apparatus.

### DETAILED DESCRIPTION

In the following description, certain specific details are set forth in order to provide a thorough understanding of various disclosed embodiments. One skilled in the art will understand, however, that the embodiments may be practiced without these details. In other instances, well-known structures associated with an encoder, printer, cutting device, perforating apparatus, scoring apparatus, circuitry, interrogators, processor, memory, computing system, antennas, transmitter, receiver, and transceivers have not been shown or described in detail to avoid unnecessarily obscuring descriptions of the various disclosed embodiments of the media processing apparatus and its components. The media processing apparatus, in some embodiments, analyzes one or more encodable objects (e.g., RFID devices, RFID tags, RFID labels, and the like) to determine an appropriate way to encode information in additional ones of the encodable objects. Such media processing apparatuses can be used to process a wide range of encodable objects.

Unless the context requires otherwise, throughout the specification and claims which follow, the word “comprise” and variations thereof, such as “comprises” and “comprising,” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

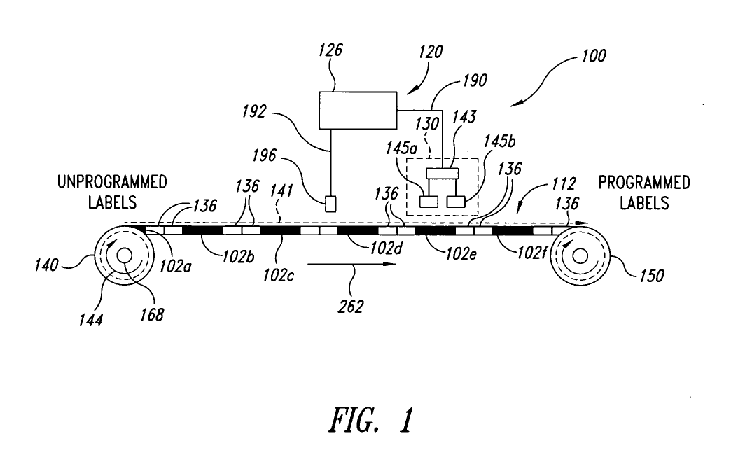

FIG. 1 shows media 112 and a media processing apparatus 100 that processes the media 112, according to one illustrated embodiment.

The media 112 includes a plurality of encodable objects 102a-102f (collectively 102). As discussed in detail below, in some embodiments the encodable objects 102 may take the form of radio frequency identification (RFID) circuits, transponders, devices, or tags. The media 112 may include a media carrier that carries the encodable objects 102a-102f. The media carrier may the form an elongated web of material. For example, the media carrier may take the form of a substrate, for instance a web of paper, vellum, MYLAR®, or mesh material. Additionally, or alternatively, the media carrier may take the form of a liner or backing, for instance a release liner such a silicone impregnated release liner for use in temporarily covering a pressure sensitive adhesive. The media 112 may additionally, or alternatively include an adhesive, for instance a pressure sensitive adhesive. The media 112 or a portion thereof may be divided or segmented into a plurality of pieces or segments. For example, all or a portion of the media 112 may be perforated, scored, creased or otherwise sectioned to create individual pieces or segments 136 which may be torn or otherwise separated from one another in use. Each one of the pieces or segments 136 may include one or more of the encodable objects 102. The media 112 may include a cover sheet or substrate, overlying the encodable objects 102.

The media processing apparatus 100 includes an encoding assembly 120 having a control subsystem 126 and a write/read subsystem 130 communicatively coupled to the control subsystem 126. The write/read subsystem 130 is operable to encode the encodable objects 120a-120f. The term “encode” is broadly construed to include, without limitation, wirelessly transmitting, wirelessly programming, or otherwise wirelessly placing information, data, executable instructions, or operating instructions into an encodable object 102.

As shown in FIG. 1, the media 112 is fed from a supply roll 140. The supply roll 140 is rotated (e.g., clockwise as illustrated in FIG. 1 indicated by the arrow 144) to move the media 112 along a media path 141 towards the write/read subsystem 130 for individually encoding each one of the encodable objects 102. In particular, the write/read subsystem 130 may a transmitter, receiver or a transceiver 143 and one or more antennas 145a, 145b (collectively 145) positioned proximate a portion of a media path 141 along which the media 112 travels. The write/read subsystem 130 can wirelessly write information to the encodable objects 102 and wirelessly read information from the encodable objects 102.

The media processing apparatus 100 can be self-calibrating to conveniently and reliably program various types of encodable objects 102 carried by various types of media. Generally, the illustrated media processing apparatus 100 of FIG. 1 can automatically self-calibrate by interacting with at least two of the encodable objects 102 to determine one or more operational parameters. Examples of operational parameters include pitch of the encodable objects 102, size of the encodable objects 102, optimal transmission power level of write/read subsystem 130, size and location of programming windows, and the like. Based on these operational parameters, the media processing apparatus 100 can encode the rest of the un-encoded encodable objects 102 with a high level of reliability, thus reducing the number of improperly encoded or un-encoded encodable objects 102. For example, the self-calibrating media processing apparatus 100 can determine the size of the segments 136, spacing of the encodable objects 102, and optimal wireless transmission power level to encode information.

As shown in FIG. 1, the media processing apparatus 100 can encode the encodable object 102e proximate the antennas 145 of the write/read subsystem 130 without encoding one of the adjacent encodable objects 102d, 102f, thus providing wireless communication between the encodable object 102e and the write/read subsystem 130 without unwanted communication to nearby encodable objects 102a-102d, 102f. The transmission of information by the write/read subsystem 130 can therefore be precisely aimed and the range controlled to encode the specifically targeted encodable object 102e (or group of encodable objects 102).

To self-calibrate, the write/read subsystem 130 can transmit information and can then attempt to read any information encoded in the encodable objects 102, if any, to determine information about those encodable objects 102. The transmission power levels of the write/read subsystem 130 and the read information are then used to generate one or more operational parameters used to accurately and reliably encode the rest of the un-encoded encodable objects 102. The control subsystem 126, for example, can use one or more of the operational parameters to selectively command the write/read subsystem 130 to individually program the encodable objects 102 without unwanted interference to nearby untargeted encodable objects 102.

The media processing apparatus 100 is disclosed in the context of encoding encodable objects 102, such as RFID devices, because it has particular utility in this context. However, the media processing apparatus 100 can be used in other contexts, such as, for example, but without limitation, to process or otherwise prepare encodable objects 102 in the form of magnetic strips, semiconductor chips, circuitry, data carriers, and other types of programmable objects. The write/head subsystem 130 of FIG. 1 can be selected based on the encoding process to be performed. If the encodable objects 102 are RFID tags, the write/read subsystem 130 can have appropriately configured antenna(s) 145, transmitter(s), receiver(s) and/or transceiver(s) 143 configured to wireless transmit information to the RFID tags, which in turn store the information. Without limitation, wireless transmission may, for example, take place in the radio or microwave portions of the electromagnetic spectrum.

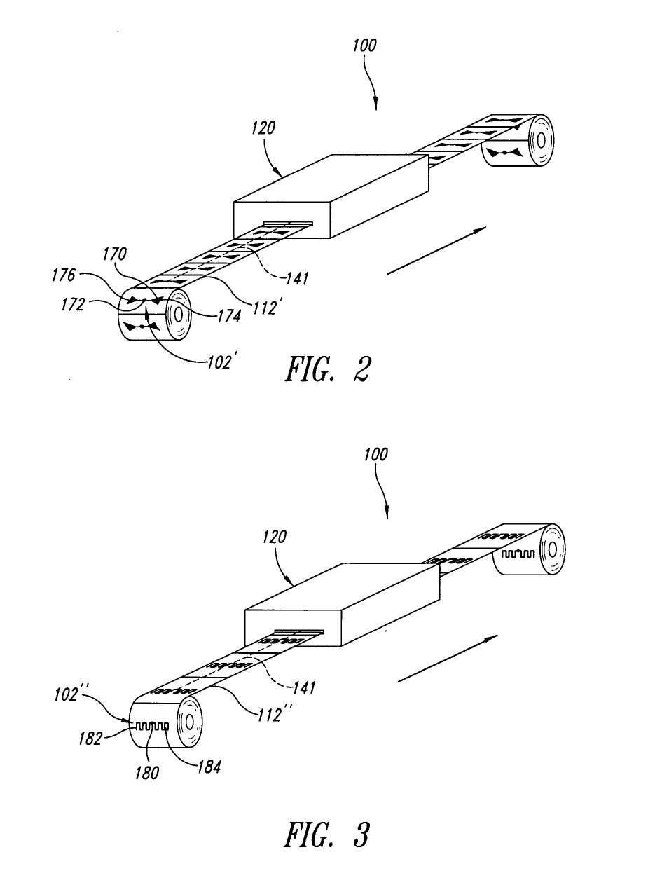

FIGS. 2 and 3 show the media processing apparatus 100 programming different types of encodable objects 102′, 102″, respectively, during different processing cycles. The illustrated encodable objects 102′, 102″ have different configurations or be positioned differently on the media carrier. Because the apparatus 100 is self-calibrating, it may effectively encode the encodable objects 102′ of the media 112′ moving along the media path 141, as shown in FIG. 2. The same media processing apparatus 100 can then encode the encodable objects 102″ of the media 112″ moving along the media path 141, as shown in FIG. 3, without requiring a user to input information or make physical adjustments which is often needed to properly operate traditional media processing apparatus.

The illustrated encodable objects 102′, 102″ in FIGS. 2 and 3 are distributed along the length of the media 112′, 112″, respectively. While not illustrated, the encodable objects 102′, 102″ may additionally, or alternatively, be distributed laterally across the media 112′, 112″, respectively, thereby allowing the simultaneous encoding of a group of encodable objects 102′ and 102″, respectively. In some embodiments, rows of encodable objects 102 are incrementally spaced along the length of the media 112. The media processing apparatus 100 can encode an entire row of encodable objects 102 in a single programming cycle. The media processing apparatus 100, for example, can be used to process pairs of encodable objects 102 in a side-by-side arrangement incrementally spaced along the length of the media 112. In such embodiments, the write/read subsystem 130 may include two or more laterally spaced antenna 145 or sets of antennas. For example, the write/read subsystem 130 may include multiple pairs of write and read antennas 145 (e.g., one antenna to write and one antenna to read), each pair of antennas laterally spaced across the media path 141 to at least approximately align with a respective line of the encodable objects 102 that are themselves laterally spaced across the media 112. Alternatively, or additionally, the media 112 can be moved laterally with respect to the media path 141 to further improve the encoding process.

In some embodiments, the encodable objects 102 may take the form of simple transponders operable to respond to an interrogation signal (e.g., RF carrier) with a signal encoding data stored in a memory. In some embodiments, the encodable objects 102 may include circuitry for performing complicated functions, such as logic operations, encryption, authentication, writing to memory, or combinations thereof. The circuitry may comprise one or more semiconductor chips and one or more electrical traces to form an antenna electrically coupled to the semiconductor chip. Various types of antennas (e.g., coil antennas, dipole antennas, and the like), chips, and semiconductors chips can be at various locations and orientations based on the desired application of the encodable objects. Additionally, the antennas can be low frequency (LF), high frequency (HF), or ultra-high frequency (UHF) antennas. For example, the encodable objects 102 can be LF RFID tags, HF RFID tags, or UHF RFID tags. Additionally, the encodable objects 102 can be passive devices or active devices. The encodable objects 102′ shown in FIG. 2 each has a semiconductor wafer 172 disposed between a pair of antennas 174, 176. Similarly, each of the encodable objects 102″ of FIG. 3 includes a semiconductor wafer 180 disposed between a pair of antennas 182, 184. Other types encodable objects 102 can also be used with the media processing apparatus 100.

As noted above, the media 112 can include a substrate suitable for transporting encodable objects 102. Exemplary types of media 112 include, without limitation, adhesive labels, tags, and the like and may include one or more face sheets, adhesive layers, release liners, and the like. The encodable objects 102 may reside on or within layers of the media 112. In some embodiments, the media 112 is a conveyor by which the encodable objects 102 are carried.

Referring again to FIG. 1, the control subsystem 126 can be coupled to the write/read subsystem 130 via a wired connection or a wireless connection 190. Similarly, a wired connection or wireless connection 192 can couple a media position detector 196 to the control subsystem 126. Other components or peripherals associated with encoders, printers, cutting devices, perforating devices, scoring devices, singulators, input devices, and the like can also be coupled to the control subsystem 126.

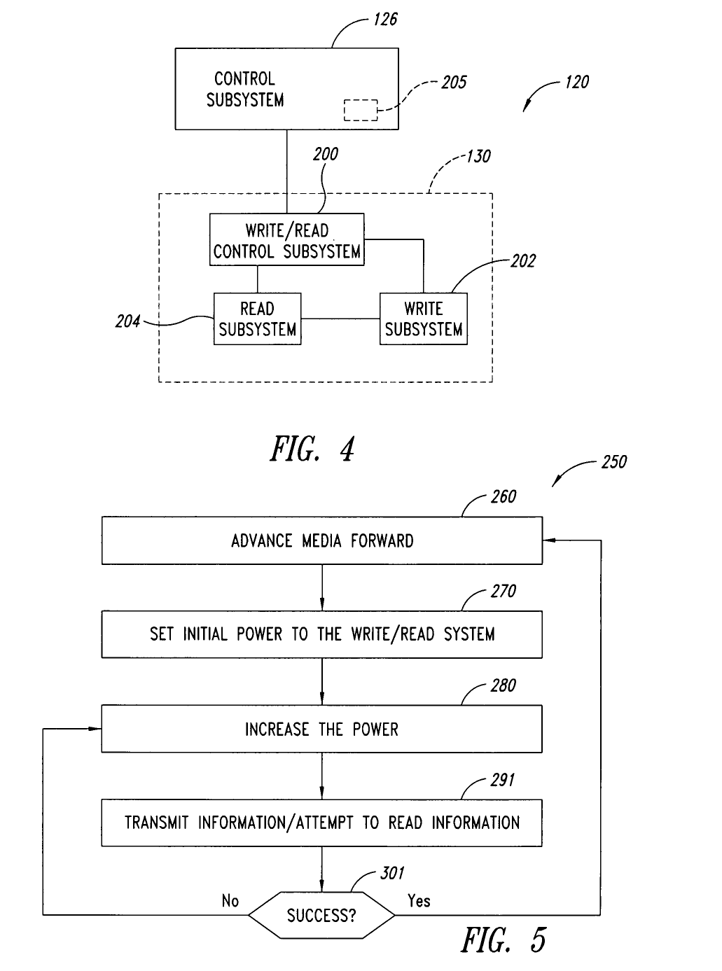

FIG. 4 is a schematic diagram of the encoding assembly 120 suitable for use with the media processing apparatus 100 of FIG. 1. The encoding assembly 120 has a write/read subsystem 130 that includes a write/read control subsystem 200 communicatively coupled to a write subsystem 202 and a read subsystem subsystem 204. The write/read control subsystem 200 can provide power to the write subsystem 202, which in turn wirelessly transmits write information for encoding in an encodable object. The read subsystem 204 can attempt to wirelessly read information to determine whether the write information is properly encoded on the encodable object 102 (FIG. 1). The write subsystem 202 and read subsystem 204 can cooperate to perform various types of calibration routines. In some embodiments, one of the control subsystems 126, 200 stores a routine for alternatingly sending information from the write subsystem 202 at a plurality of power levels (e.g., successively increasing or decreasing transmission power levels) and performing read inquiries with the read subsystem 204. In embodiments in which the transmission power levels are increased, the process can be performed until at least one transmission of information is encoded in an encodable object and read by the read subsystem 204. The transmitted information can include without limitation, data, instructions, executable code, and other storable, wirelessly transmittable data.

Control subsystems 126, 200 may generally include, without limitation, one or more controllers, processors, microprocessors, digital signal processors (DSP), application-specific integrated circuits (ASIC), and the like. To store information, controllers may also include one or more storage devices, such as volatile memory, non-volatile memory, read-only memory (ROM), random access memory (RAM), and the like. The storage devices can be coupled to the controllers by one or more busses. The control subsystem 126 of FIG. 4 may further include one or more input devices 205 (e.g., a display, keyboard, touchpad, controller module, or any peripheral device for user input). In some embodiments, the control subsystem 126 may take the form of a write and/or read controller.

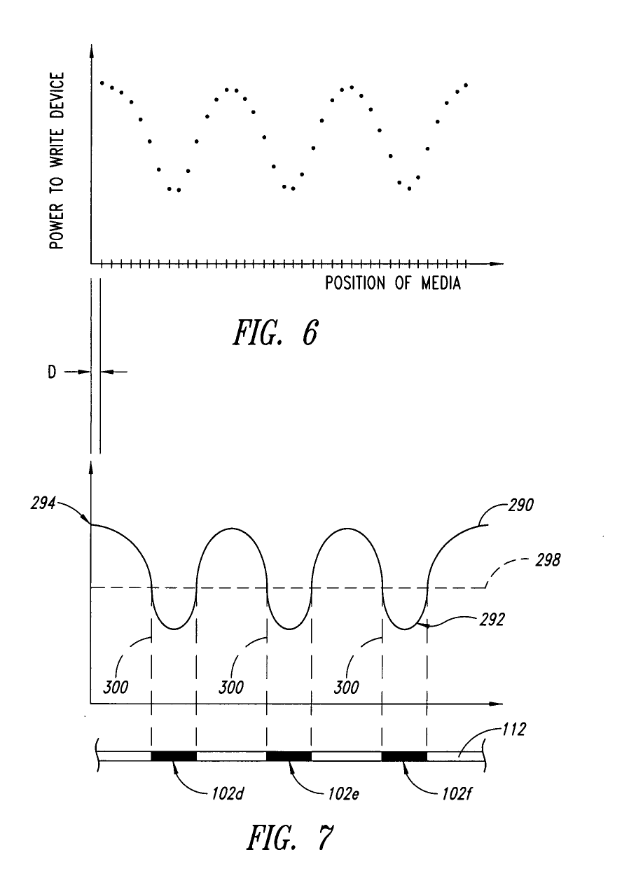

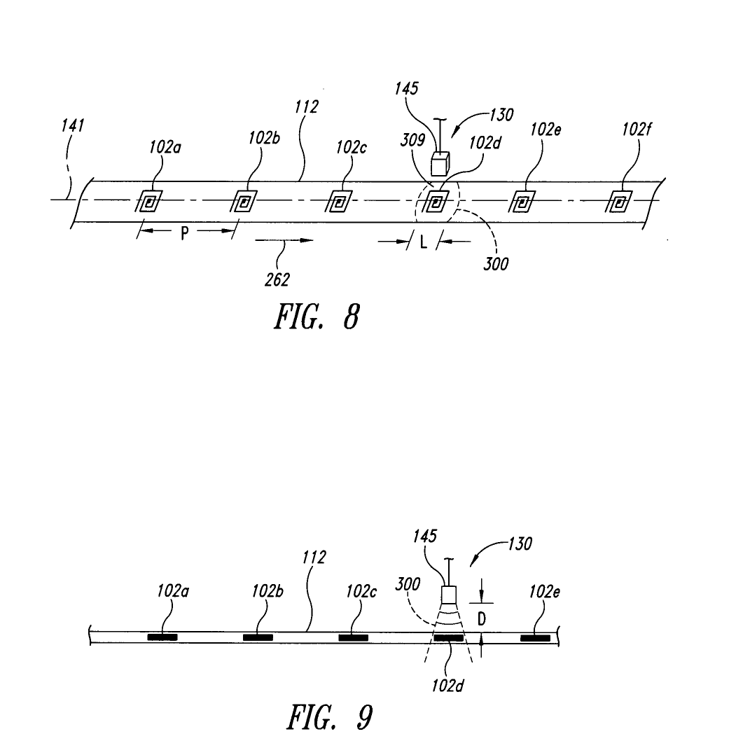

The control subsystem 126 may be configured to compare one or more transmission power levels (e.g., power levels of the write subsystem 202), read signals, write signals, positions (e.g., positions of media and/or encodable objects), and other measurable criteria. The control subsystem 126 can generate one or more responses based, at least in part, on the comparison detailed below. Additionally, the control subsystem 126 can have a database of stored data, which may include data related to the encoding process. As described in connection with FIGS. 6 and 7, the control subsystem 126 can perform various computations using collected data.

The write/read control subsystem 200 may be somewhat similar to the control subsystem 126. In some embodiments, the control subsystem 126, 200 can be integrated together to form a single control system. The write/read control subsystem 200 and read subsystem 204 may include a number of conventional components, such as those disclosed in U.S. Pat. Nos. 5,828,693 and 5,850,181, which are both hereby incorporated by reference. As is appreciated by one of skill in the art, the media processing apparatus 100 may include additional components such as those disclosed in U.S. Pat. Nos. 5,828,693 and 5,850,181.

The control subsystem 200 can include a controlled attenuator that selectively adjust one or more operating parameters, such as the power level of the write write/read subsystem 130, frequency of the outputted carrier signal, and other parameters known in the art. Hardware, software, and combinations thereof can be used to achieve the power level modification, while a software controlled oscillator such as a voltage controlled oscillator (“VCO”) can achieve frequency modification. One of skill in the art will recognize that the response is dependent on a number of parameters, and that these parameters can be maintained within certain tolerances to accurately measure the response. These parameters include antenna-to-object distances, ambient noise level, reflective and other objects and apparatus parts in the vicinity of the antenna, ambient temperatures, and other parameters known in the art.

The write subsystem 202 can be configured to wirelessly transmit write information capable of being encoded on at least one encodable object 102. If the encodable objects 102 are RFID objects, the write subsystem 202 may take the form of an RF or microwave transmitter or transceiver 143 that emits an RF signal that is subsequently encoded on an RFID object. The transmitter or transceiver 143 may include an amplifier and a modulator. The transmitter or transceiver 143 can have an antenna 145a or other device for emitting and directing a sufficient amount of RF or microwave energy to the RFID circuitry. The antenna 145a may advantageously be a directional antenna. Other types of write elements can also be used to perform various types of programming or encoding processes.

The read subsystem 204 can wirelessly receive information (e.g., modulated data) from an encodable object 102 and can send a signal indicative of the reception of information. The read subsystem 204 can include a receiver or transceiver 143 that receives an RF or microwave signal from an RFID object. The receiver or transceiver 143 may include a demodulator. The receiver or transceiver 143 may also include an antenna 145b for receiving or other device to receive RF or microwave energy returned by the RFID object. The antenna 145b may advantageously be a directional antenna.

If the encodable object 102 is passive, the read subsystem 204, or other powering device, can power the encodable object 102 such that the encodable object can transmit information stored therein. If the encodable object 102 is active, it can send stored information to the read subsystem 204 without being externally powered. The term “read subsystem” is broadly construed to include, without limitation, verifiers, interrogators, controllers, read elements, or other devices used to receive information from encodable objects as well as other components used to communicate with encodable objects 102.

The media position detector 196 (FIG. 1) can be used to determine the position of the media 112 relative to the write/read subsystem 130, or relative to any other component of the media processing apparatus 100 or point of reference. The media position detector 196 can then send position information indicative of the measured or otherwise sensed or determined position. An object-to-write/read subsystem 130 distance, for example, can be determined using the media position detector 196. Such may represent the distance between an encodable object and the antenna(s) 145 of the write/read subsystem 130. The media 112 can optionally include location indicators used to determine the position of the media 112. Some embodiments of the media 112 includes location indicators incrementally spaced along its length. The media position detector 196 can recognize the location indicators to determine the position of the media 112.

Additionally or alternatively, one or more position detectors can be positioned on, or adjacent to, the supply roll 140, output roll, or both. These position detectors can measure the rotational speed (e.g., revolutions per minute) of a roll, diameter of the media wound on the roll, position or line speed of encodable objects 102 or other measurable criteria used to determine the position of media 112 and/or encodable objects 102.

FIG. 5 shows a method 250 of calibrating the media processing apparatus 100 of FIG. 1, according to one illustrated embodiment.

Generally, the media processing apparatus 100 loaded with the media 112 can analyze at least two of the encodable objects 102 to determine one or more parameters that are subsequently used to encode the other encodable objects 102. The media processing apparatus 100 selectively controls the power level of the write/read subsystem 130 transmitting information towards the media 112. If the information was successfully encoded, the media 112 is advanced along the media path 141 to repeat the process. If the information was not encoded, the transmission power level of the write/read subsystem 130 is increased and the information is transmitted again towards the media 112. In this manner, the media processing apparatus 100 sends information transmissions at successively increasing power levels until information is encoded on one of the encodable objects 102. The media 112 is then advanced along the media path 141 so that the process can be repeated. Based on the settings of the media processing apparatus 100, the control subsystem 126 can determine an appropriate program for encoding the rest of the encodable objects 102.

Once the apparatus 100 is loaded with the media 112, at 260 the media 112 is advanced forward a predetermined distance in the direction of the arrow 262 (FIG. 1). For example, a motor (e.g., a stepper motor) can be used to advance the media 112 in small steps. The distance of travel can be input by a user based on, for example, visual inspection of the media 112 (e.g., estimated distance between encodable objects), product specifications for the media 112, and the like. The distance of advancement can be a fraction of the distance between adjacent encodable objects 102 in the direction of media travel 262. In such embodiments, data can be generated when the write/read subsystem 130 is at various intermediate positions between the encodable objects 102. The distance of advancement can be decreased or increased to increase or decrease the accuracy of the calibration process, as discussed in connection with FIGS. 6 and 7.

At 270, the power to the write/read subsystem 130 can be set at an initial power level. The initial power level should be less than the power level required to encode the encodable object 102e nearest the antenna 145 so that the apparatus 100 can incrementally increase the power level of the write/read subsystem 130 until reaching a power level suitable for encoding the encodable object 102e nearest the antenna 145.

In some embodiments, the power level can be reduced if the initial wireless transmission of information from the write/read subsystem 130 is encoded in one of the encodable objects 102. The write/read subsystem 130 at the set power mode emits write information from the antenna 145a. The transmission of information is configured to be encoded in at least one of the encodable objects 102. In some embodiments, the write/read subsystem 130 emits write information at a power level at a predetermine increment greater than a power level input by the user. The user can select an appropriate initial power level of the write/read subsystem 130 based on the configuration of the encodable objects 102, media 112, type of signal to be encoded, and the like.

If one of the encodable objects 102e is within range of the write/read subsystem 130, the encodable object 102e is encoded with the information. If all of the encodable objects 102 are out of range, the write device 130 will not encode any of the encodable objects 102. The read subsystem 204 can attempt to communicate with the encodable objects 102 to determine whether the information just sent from the write subsystem 202 is properly encoded.

At 280, the power of the write/read subsystem 130 can be increased from the initial power level a desired amount. In some embodiments, the increase in power level at 280 can be omitted. That is, after the minimum power level is set at 270, the write/read subsystem 130 can then perform 291.

At 291, the write/read subsystem 130 at the initial power level (assuming 280 is omitted), or a higher power level, sends one or more transmissions of information and performs one or more read inquiries to determine if any of the transmissions were successfully encoded in at least one encodable object 102.

If the encodable objects 102 are passive, the write/read subsystem 130 can transmit a power signal that powers one of the encodable objects 102. The powered encodable object 102 may respond with a signal indicating that it is ready for programming. The write subsystem 202 can then transmit information towards the media 112. The read subsystem 204 can then attempt to read information from the encodable object 102.

If an encodable object 102 was properly encoded, the encodable object 120 emits a signal indicating that it was properly encoded in response to the interrogation signal. If the encodable object 102 is an active device (e.g., the encodable object includes a power source), if may not be necessary for the write subsystem 202 to send a signal sufficient to power the encodable object 102. The read subsystem 204 can then send an interrogation signal towards the media 112. If an encodable object 102 was properly encoded, the internally powered encodable object 102 emits a signal indicating that it was properly encoded in response to the interrogation signal.

At 301, the control subsystem 126 determines whether information was successfully encoded. The control subsystem 126, in some embodiments, can compare the signal from the write subsystem 202 and any information from the encodable object 102 to determine whether the encodable object 102 was properly encoded. In some embodiments, a plurality of encodable objects 102 are encodable by a single transmission of information. For example, if the write subsystem 202 is positioned midway between two encodable objects 102, the write subsystem 202 may simultaneously program both encodable objects 102. Based on the signals received by the read subsystem 204, the control subsystem 126 may determine the number of encodable objects 102 that were encoded by the most recent transmission. The control subsystem 126 is configured to evaluate one or more signals from the read subsystem 204 and to generate one or more responses. The responses can be, for example, to advance the media 112, to adjust the power of the write/read subsystem 130, to send additional information, and the like.

In the illustrated embodiment of FIG. 5, at 260 the control subsystem 126 can generate a first response to advance the media 112 along the media path 141 when information from the write subsystem 202 at an initial or first power level is encoded. If the control subsystem 126 determines that one or more of the encodable objects 102 is encoded, the control subsystem 126 increases the power to the write subsystem 202 to a second power level greater than the first power level. In this manner, the power of the write subsystem 202 can be increased until at least one of the encodable objects 102 is successfully encoded.

The media position detector 196 can detect a position of the media 112 and to send position information indicative of the position of the media 112 to the control subsystem 126. The control subsystem 126 can use the position information to track the positions of the media 112 and corresponding transmission power levels of the write subsystem 202 when the write subsystem 202 encodes at least one encodable object 102. The control subsystem 126 is configured to evaluate tracking information based on signals from the write/read subsystem 130.

FIG. 6 is an exemplary plot of the power to the write subsystem 202 that encoded one of the encodable objects 102 versus the position of the write/read subsystem 130 relative to the media 112 in the direction 262 of the media path 141. In some embodiments, the apparatus 100 uses read signals from the read subsystem 204 and power levels of the write subsystem 202 to obtain the data shown in FIG. 6. The read signals and the power levels are obtained by alternatingly transmitting information from the write subsystem 202 at successively increasing power levels and determining whether the information has successfully encoded any encodable objects 102. The method 250 of FIG. 5 is used to determine the plotted power of the write/read subsystem 130. As noted above, the distances along the abscissa between adjacent data points are determined by the distances the media 112 is advanced at 260. Accordingly, more data points can be collected by reducing the distance of advancement at 260. The ordinate corresponds to the power level of the write/read subsystem 130 that successfully encodes information in a target encodable object 102. The controller 200 can use the data to track various parameters, such as the power level of the write/read subsystem 130, size of a feature of the media 112 (e.g., length of label 136, spacing of the encodable objects 102, operational window or power level, and the like), read signals from the write subsystem 202, position of the media 112, and the like.

The raw data of FIG. 6 can be used to determine approximate consecutive local minimums, consecutive local maximums, or other characteristics indicative a feature of the media 112. For example, the distance between the local minimums and maximums can be used to determine the label size, pitch P (in FIG. 8) of the encodable objects 102, operational power levels (e.g., the operational power level 298), operational encoding windows (e.g., encoding windows 300), and other features or characteristics of the media 112 or encodable objects. The local minimums correspond to the approximate pitch of the encodable objects 102 taken from the center of each piece or segment (e.g., tag). The distance D (the distance between adjacent measured power levels of FIG. 6) can be decreased or increased to increase or decrease the accuracy of the calibration process.

FIG. 7 shows two different power levels of the write/read subsystem 130 versus the position along the media 112. The curve 290 is a curve generated based on the data of FIG. 6. The control subsystem 126 can optionally use curve fitting techniques to generate the curve 290. Curve fitting based on polynomials, trigonometric functions, and combinations thereof can be used to determine a curve approximating the collected data of FIG. 6. Various types of regression techniques can be used to evaluate the data points. After generating the curve 290, the consecutive local maximums, consecutive local minimums, or other parameters of the curve 290 can be evaluated.

Based on the minimums 292 and maximums 294, the control subsystem 126 can determine an operation power level 298 of the write subsystem 202 for reliably encoding one encodable object 102 at a time such that interference with other encodable objects 102 is kept at or below a predetermined level. The intersection of the operational power level 298 and the curve 290 generally defines an encoding window 300. The write subsystem 202 at the operational power level 298 can encode any encodable object within the encoding window 300. In some embodiments, the write subsystem 202 can be continuously maintained at or near the operational power level 298 as the media 112 is moved through the media processing apparatus 100. Each encodable object 102 is encoded as it passes by the write/read subsystem 130. In other embodiments, the write subsystem 202 can be at the operational power level 298 when an encodable object 102 is in the encoding window 300 and OFF when the encoding window 300 is empty, thus reducing the amount of energy used to encode the encodable objects 102. The control subsystem 126 can determine an optimal encoding window using numerical analysis. The control subsystem 126 can also be configured to determine the operational power level based, at least in part, on a comparison of power levels and the positions of the media during the calibration process.

FIGS. 8 and 9 show the stationary encoding window 300 defined beneath the write/read subsystem 130. As the media 112 is moved along the media path 141 in the direction indicated by the arrow 262, the encodable objects 102a-102f (collectively 102) pass into and through the encoding window 300 fixed relative to the write/read subsystem 130. The encodable object 102d at the illustrated position 309 is encoded with information. In this manner, the encodable objects 102 of the media 112 are encoded successively as they are moved within range of the antenna 145 of the write/read subsystem 130. The distance between the media path 141 and the write/read subsystem 130 can adjusted to achieve the desire size of the encoding window 300. The operational encoding power level 298 can be increased or decreased if the distance D is increased or decreased. In some embodiments, including the illustrated embodiment of FIGS. 8 and 9, the length L of the encoding window 300 is less than the pitch of the encodable objects 102, thus ensuring that only one encodable object 102 is encoded at a time without unwanted interference to any other encodable objects 102.

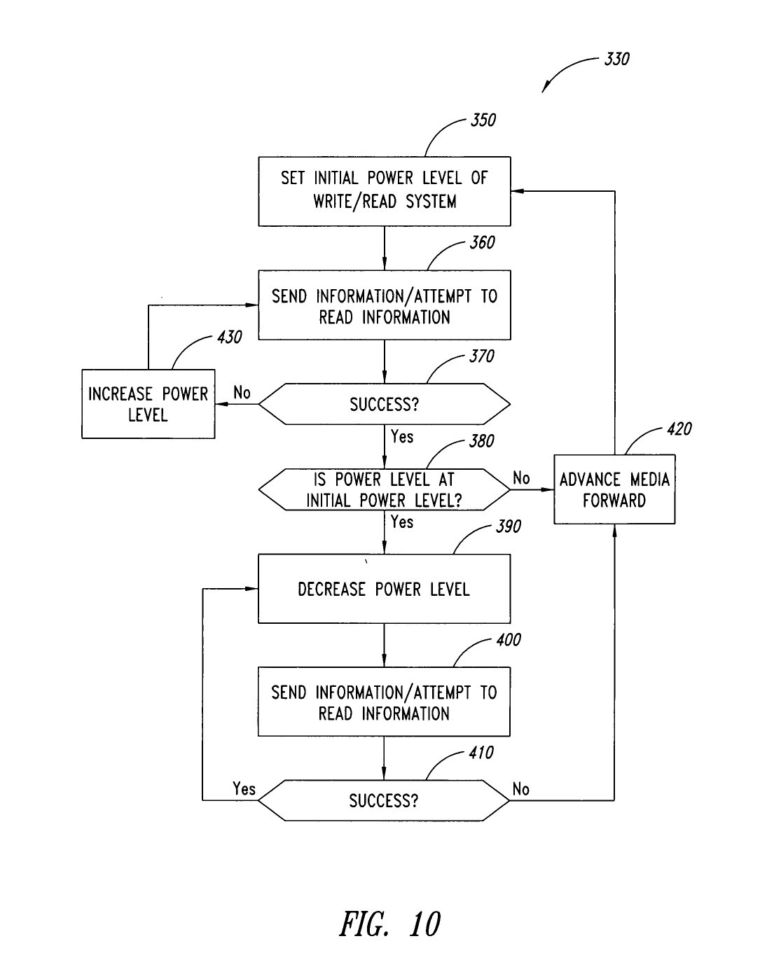

FIG. 10 shows a method 330 of calibrating the media processing apparatus 100 of FIG. 1, according to one illustrated embodiment.

Advantageously, the method 330 can determine appropriate minimum power levels required to encode at least one encodable object 102 irrespective of the initial transmission power level of the write/read subsystem 130. The method 330 is generally similar to the method 250 of FIG. 5, except as detailed below.

At 350, the initial transmission power level of the write/read subsystem 130 is set. The write/read subsystem 130 transmits information 360 designed to encode encodable objects 102.

At 370, the apparatus 100 determines whether the write/read subsystem 130 successfully encoded at least one encodable object 102. If any encodable object 102 was properly encoded, the controller 126 evaluates the power level of the write/read subsystem 130 at 380. If the write/read subsystem 130 sent the information at the initial power level, the power level is decreased at 390. The power level can be decreased in a similar manner as the power level is increased at 280 of FIG. 5.

At 400, the write/read subsystem 130 transmits information at the lowered power level to determine the minimum power to encode the encodable object 102. If the encodable object 102 is not encoded again, the media 112 is advanced forward 420 and returns to 350.

If the controller 126 determines that the write/read subsystem 130 re-encoded the encodable object 102 at 410, the power level of the write/read subsystem 130 is decreased at 390. In this manner, the power level of the write/read subsystem 130 can be incrementally decreased until the write/read subsystem 130 is at a power level too low to re-encode the encodable object 102 and proceeds to 420 such that the media is advanced forward. The method 330 is repeated.

If the write/read subsystem 130 did not properly encode an encodable object 102 at 370, the power can be increased to the write/read subsystem 130 to determine an appropriate power level for encoding the encodable objects 102 by proceeding to 430.

At 430, the power level of the write/read subsystem 130 is increased and the method continues at 360. The power level of the write/read subsystem 130 can be incrementally increased until it successfully encodes at least one encodable objects 102 and proceeds to 380. Because the power level of the write/read subsystem 130 is greater than the initial power level of the write/read device at 350, the media 112 is advanced to 420 and then returned to 350.

The method 330 can be used to calibrate the apparatus 100 for media having encodable objects 102 encodable at extremely low power levels and media having encodable objects 102 encodable only at extremely high power levels, even if one initial power level is used for multiple media. Of course, the initial power level at 350 can be changed during the calibration process or between printing of different media 112.

After the encodable objects 102 of the media 112 are programmed, the media 112 can be subsequently processed to prepare the encodable objects 102 for use. When the encodable objects 102 are used for tracking products, the segments of the media 112 can be in the form of labels that can be cut apart, torn or otherwise separate and coupled to products via an adhesive. The media processing apparatus 100 can program the labels at various stages of the manufacturing process.

As noted above, the media 112 may take a variety of forms based on its use, and may include labels having one or more layers. For example, the media 112 may include one or more face sheets, adhesive layers, release liners, and the like. Face sheets typically employs one or more components or layers, such as paper, polymers, polyester, MYLAR®, TYVEK®, plastic, polyamide, poly-ether-ether-ketone, FR4, and/or other materials. Adhesive layers typically take the form of a pressure sensitive or self-adhesive. Release liners typically take the form of a waxed or treated material that is selectively releasable from the adhesive layer. Thus, a user may expose the adhesive layer by removing the release liner, allowing the user to adhere the encodable object 102 or label to any desired surface. In some instances, linerless media may be employed. Linerless media typically requires some action to activate the adhesive, for example the addition of heat and/or moisture. Linerless media typically omits the release liner. In some embodiments, the media 112 is a monolayer continuous sheet, and the encodable objects are embedded in, overlay, or are otherwise carried by the media 112. Various types of mono and multilayer medias can be used to transport the encodable objects within range of the encoding assembly 120.

If the media 112 is a multilayer media, the encodable objects 102 may reside on, or in, any of the layers of the media 112. In some embodiments, the encodable objects 102 can underlie a face sheet, thereby providing some environmental protection to the encodable objects. For example, the encodable objects 102 can be carried between the face sheet and an adhesive layer. In other embodiments, the encodable objects 102 can be positioned between the adhesive layer and the release liner. Additionally or alternatively, the encodable objects 102 may be carried on an additional independent layer. For example, the encodable objects 102 may reside on separate substrates, allowing the high speed insertion of encodable objects into the media 112 to create more complicated labels.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus for preparing media, the media including a plurality of encodable objects spaced from one another along a length of the media, the apparatus comprising:
a media path along which the media travels;
a write subsystem configured to wirelessly transmit information for successively encoding the encodable objects as each of the encodable objects is proximate a first position along the media path;
a read subsystem configured to read information encoded in at least one of the encodable objects, if any, and to provide a signal indicative of whether the write subsystem has encoded the information in at least one of the encodable object; and
a control subsystem communicatively coupled to the write subsystem and the read subsystem and configured to advance the media along the media path in response to the signal from the read subsystem indicating that the write subsystem has encoded the information on a respective one of the encodable objects and to wirelessly retransmit the information at a higher power level in response to the signal from the read subsystem indicating that information previously transmitted by the write subsystem was not encoded on the respective one of the encodable objects.

2. The apparatus of claim 1 wherein the control subsystem is configured to adjust a power level of an initial wireless transmission of information to a next one of the encodable objects based at least in part on a power level of a wireless transmission at which information was encoded into at least a current or a previous one of the encodable objects.

3. The apparatus of claim 1 wherein the control subsystem is configured to determine an operational wireless transmission power level of the write subsystem based, at least in part, on a comparison of a plurality of wireless transmission power levels of the write subsystem and a plurality of signals from the read subsystem, wherein, when the write subsystem wirelessly transmits at the operational wireless transmission power level, the write subsystem encodes information into a single one of the encodable objects proximate the first position of the media path.

4. The apparatus of claim 1 further comprising:
a media position detector coupled to the control subsystem, the media position detector configured to detect a position of the media and to send a position signal indicative of the position of the media, wherein the control subsystem uses the position signal to track positions of the encodable objects and corresponding wireless transmission power levels of the write subsystem when the write subsystem encodes the encodable objects.

5. The apparatus of claim 1 wherein the control subsystem is configured to evaluate tracking information based on a plurality of signals from the read subsystem and a plurality of wireless transmission power levels of the write subsystem, wherein the plurality of signals from the read subsystem and the plurality of wireless transmission power levels are obtained by alternatingly wirelessly transmitting information from the write subsystem at successively increasing power levels and determining whether the information wirelessly transmitted from the write subsystem has encoded at least one of the encodable objects.

6. The apparatus of claim 5 wherein the control subsystem is configured to determine an encoding window and an encoding transmission power level based on the tracking information; wherein the write subsystem at the encoding transmission power level encodes any of the encodable objects in the encoding window without encoding any adjacent encodable object that is outside of the encoding window.

7. The apparatus of claim 6 wherein the encoding window corresponds to a region about the first position of the media path.

8. The apparatus of claim 1 wherein the media is substantially stationary relative to the write subsystem as the write subsystem wirelessly transmits the information at a plurality of transmission power levels until the information is encoded in at least one of the encodable objects.

9. The apparatus of claim 1 wherein the write subsystem includes a transmitter and an antenna.

10. The apparatus of claim 1 wherein the read subsystem includes a receiver and an antenna.

11. An apparatus for preparing a plurality of encodable objects, comprising:
a control subsystem;
a write subsystem communicatively coupled to the control subsystem, the write subsystem configured to wirelessly transmit information for encoding at least one of the encodable objects;
a read subsystem communicatively coupled to the control subsystem, the read subsystem configured to wirelessly read information encoded in one of the encodable objects, if any; and
a position detector configured to detect a position of the plurality of the encodable objects and to send a signal indicative of the position of the plurality of encodable objects;
wherein the control subsystem is configured to determine an encoding window based, in part, on a plurality of position signals from the position detector and a plurality of transmission power levels of the write subsystem at which the write subsystem transmitted information and to determine an operational transmission power level for the write subsystem such that the write subsystem at the operational signal indicative power level encodes information in one of the encodable objects in the encoding window without encoding that information in any of the encodable objects outside of the encoding window.

12. The apparatus of claim 11 wherein the control subsystem is configured to encode each of the encodable objects when each of the encodable objects is in the encoding window.

13. A method of preparing a plurality of encodable objects, the method comprising:
wirelessly transmitting information from a write subsystem at a first power level;
determining with a read subsystem whether the information wirelessly transmitted from the write subsystem is encoded in at least one of the encodable objects; and
generating a response based, at least in part, on the determining of whether the write information from the write subsystem is encoded in the at least one of the encodable objects, if any; wherein the response comprises:
in response to determining that the information wirelessly transmitted by the write subsystem at the first power level is encoded in one of the encodable objects, moving the plurality of encodable objects relative to at least a portion of the write subsystem; or
in response to determining that the information wirelessly transmitted by the write subsystem at the first power level is not encoded in at least one of the encodable objects, wirelessly transmitting the information from the write subsystem at a second power level, and determining whether the information wireless transmitted from the write subsystem at the second power level is encoded in at least one of encodable objects.

14. The method of claim 13 further comprising:
wirelessly transmitting information from the write subsystem until one of the encodable objects is encoded;
moving the plurality of encodable objects relative to at least a portion of the write subsystem; and
after moving the plurality of the encodable objects, repeating successively the wirelessly transmitting of information, determining whether one of the encodable objects is encoded with the most recently transmitted write information, and generating another response based on whether the most recently transmitted write information is encoded in any of the encodable objects.

15. A method of preparing a plurality of encodable objects, comprising:
alternatingly wirelessly transmitting information from a write subsystem at a first plurality of power levels and determining with a read subsystem whether the information wirelessly transmitted from the write subsystem is encoded in a respective encodable object, if any;
after determining that information from the write subsystem is encoded in the respective encodable object, moving the plurality of encodable objects relative to at least a portion of the write subsystem; and
after moving the plurality of encodable objects, wirelessly transmitting information from the write subsystem at a second plurality of power levels and determining with the read subsystem whether the information wirelessly transmitted from the write subsystem at the second plurality of power levels is encoded on the previously encoded encodable object or another encodable object.

16. The method of claim 15 wherein wirelessly transmitting information from the write subsystem at the first plurality of power levels comprises sending information at successively increasing power levels.

17. The method of claim 15 wherein the first plurality of power levels are substantially equal to the second plurality of power levels.

18. The method of claim 15 wherein the first plurality of power levels comprises a different number of power levels than the second plurality of power levels.

19. The method of claim 15 further comprising:
determining a transmission power level of the write subsystem such that write subsystem at the transmission power level successively encodes one encodable object at a time.

20. A method for preparing a plurality of spaced apart encodable objects movable along a processing path with an encoding apparatus, the encoding apparatus comprising a write subsystem and a read subsystem, the method comprising:
determining an operational wireless transmission power level for the write subsystem to wirelessly transmit information; and
determining an encoding window such that, when the write subsystem is at the operational wireless transmission power level, the write subsystem encodes information in any of the encodable objects in the encoding window without encoding that information in any of the encodable objects outside of the encoding window.

21. The method of claim 20 wherein determining the operational wireless transmission power level for the write subsystem comprises:
moving the plurality of spaced apart encodable objects along the processing path between a first position and a second position;
when one of the encodable objects is at least proximate the second position, wirelessly transmitting information from the write subsystem at a plurality of power levels and attempting to read information with the read subsystem to verify whether at least one of the encodable objects, if any, is encoded with the transmitted information.

22. The method of claim 20 wherein the encoding window is a region of the processing path.

23. The method of claim 20 wherein the determining of the encoding window includes determining a spacing of the encodable objects.

24. The method of claim 20 wherein the operational wireless transmission power level is a range of power levels at which the write subsystem successively encodes information on respective encodable objects passing through the encoding window.

25. The method of claim 20 further comprising:
wirelessly transmitting information from the write subsystem at the operation wireless transmission power level to encode information in additional encodable objects when each of the additional encodable objects is in the encoding window.

26. An apparatus for preparing a plurality of encodable objects movable along a processing path, the plurality of encodable objects capable of storing and transmitting information, the apparatus comprising:
a write subsystem configured to wirelessly transmit information;
a read subsystem configured to receive information transmitted from at least one of the encodable objects;
a position detector for determining positions of the encodable objects relative to at least a portion of the apparatus; and
a control subsystem communicatively coupled to the write subsystem, the read subsystem, and the position detector, the control subsystem configured to wirelessly transmit information from the write subsystem at a plurality of power levels and to attempt to read information with the read subsystem to determine whether the information wirelessly transmitted from the write subsystem was stored in one of the encodable objects when the encodable objects are at different positions along the processing path and to track at least some of plurality of power levels of the write subsystem and corresponding positions of the plurality of encodable objects.

27. The apparatus of claim 26 wherein the control subsystem is configured to determine a transmission range and a wireless transmission power level based, at least in part, on the tracking of some of the plurality of power levels of the write subsystem and corresponding positions of the plurality of encodable objects, wherein a transmission of information at the operational wireless transmission power level is stored on any one of the encodable objects within the transmission range without being stored on any encodable object outside of the transmission range.

28. The apparatus of claim 26 wherein the control subsystem is configured to determine relative positions of the encodable objects based at least in part on a power level of a transmission of information at which the information is stored on at least two of the encodable objects.
